(19) United States
(12) Patent Application Publication
(10) Pub. No.: US 2021/0248312 A1
(43) Pub. Date: Aug. 12, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Naoto KASHIWAGI, Kanagawa (JP); Daiki MATSUOKA, Kanagawa (JP)

(73) Assignee: FUJI XEROX CO., LTD., Tokyo (JP)

(21) Appl. No.: 17/009,343

(22) Filed: Sep. 1, 2020

(30) Foreign Application Priority Data
Feb. 6, 2020 (JP) 2020-019071

(51) Int. Cl. G06F 40/197; G06F 40/166

(52) U.S. Cl. CPC G06F 40/197; G06F 40/166

(57) ABSTRACT

An information processing apparatus includes at least one processor configured to cause a display to present an interrelationship that represents one or more associations between plural files, the interrelationship being determined in accordance with a history of operation of the plural files performed in a state in which the plural files are presented on the display.

### CROSS-REFERENCE TO RELATED APPLICATIONS

This application is based on and claims priority under 35 USC 119 from Japanese Patent Application No. 2020-019071 filed Feb. 6, 2020.

### BACKGROUND

### (i) Technical Field

The present disclosure relates to an information processing apparatus and a non-transitory computer readable medium.

### (ii) Related Art

Japanese Unexamined Patent Application Publication No. 2013-122701 discloses an information retrieval apparatus including a profile generation unit, a recommendation-score calculation unit, and a recommended-document display unit. The profile generation unit generates from document-operation-history information the profile information to be used for recommendation. The document-operation-history information records an operation history for each kind of operation that is performed by a user on registered documents. The recommendation-score calculation unit analyzes the profile information generated by the profile generation unit and calculates a recommendation score of each of the documents in accordance with the analysis result. The recommended-document display unit causes a display device to display recommended documents whose recommendation scores are calculated by the recommendation-score calculation unit.

### SUMMARY

A plurality of files are associated with each other in accordance with histories of operations on the plurality of files while those files are opened. In some cases, when a user performs an operation on a target file of the plurality of files that are associated with each other, other files associated with the target file are also displayed. In such a case, a file that the user does not intend to associate with the target file, such as a file having insignificant relevance to the target file, is also displayed in some cases.

Aspects of non-limiting embodiments of the present disclosure relate to providing an information processing apparatus that enables a user to grasp an interrelationship between a plurality of files in accordance with associations between the plurality of files. The plurality of files are associated with each other when the user performs operations on the plurality of files while the plurality of files are presented.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including at least one processor configured to cause a display to present an interrelationship that represents one or more associations between a plurality of files, the interrelationship being determined in accordance with a history of operation of the plurality of files performed in a state in which the plurality of files are presented on the display.

### BRIEF DESCRIPTION OF THE DRAWINGS

An exemplary embodiment of the present disclosure will be described in detail based on the following figures, wherein:

FIG. 1 is an illustration depicting a schematic configuration of an information control system including information processing apparatuses according to the present exemplary embodiment;

FIG. 2 is a block diagram depicting a hardware configuration of a user terminal;

FIG. 3 is a block diagram depicting a hardware configuration of a server;

FIG. 4 is a block diagram depicting an example of a functional configuration of the user terminal;

FIG. 5 is a block diagram depicting an example of a functional configuration of the server;

FIG. 6 is an illustration depicting an interrelationship diagram presented on a display of the user terminal;

FIG. 7 is an illustration depicting meanings represented by association lines in the interrelationship diagram depicted in FIG. 6;

FIG. 8 is an illustration depicting a file that contains confidential information and a file that contains no confidential information in the interrelationship diagram depicted in FIG. 6;

FIG. 9 is a flowchart depicting a flow of an information processing operation performed by using the user terminal;

FIG. 10 is a flowchart depicting a flow of a change process performed by using the user terminal for changing the interrelationship diagram;

FIG. 11 is an illustration depicting a display screen that is displayed on the display of the user terminal and that presents a warning dialog appearing before removing an association;

FIG. 12 is an illustration depicting a display screen that is displayed on the display of the user terminal and that presents a warning dialog appearing before canceling an edit;

FIG. 13 is a flowchart depicting a flow of an update process performed by using the user terminal for updating the interrelationship diagram;

FIG. 14 is a flowchart depicting a flow of a transmission process performed by using the user terminal for transmitting information regarding the interrelationship; and

FIG. 15 is an illustration depicting a display screen that is displayed on the display of the user terminal and that presents a warning dialog appearing before transmitting the interrelationship.

### DETAILED DESCRIPTION

Hereinafter, an exemplary embodiment according to the present disclosure will be described with reference to the drawings. In the figures, the same or equivalent components and parts are denoted by the same reference signs. The sizes and proportions in the figures are emphasized for the sake of description and are not necessarily drawn to scale.

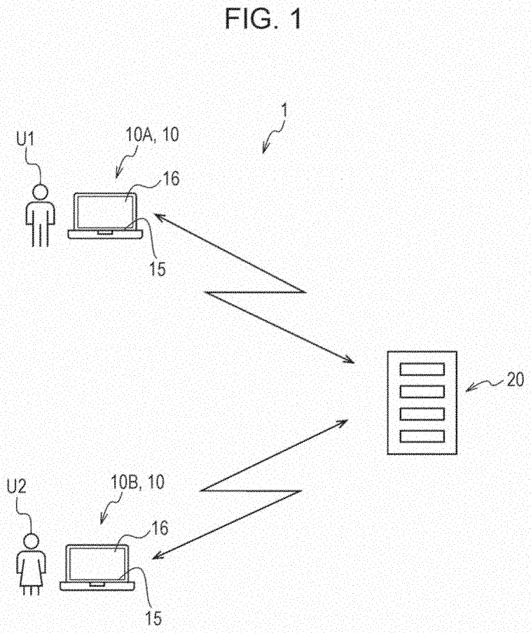

FIG. 1 is an illustration depicting a schematic configuration of an information control system according to the present exemplary embodiment.

As depicted in FIG. 1, an information control system 1 includes a plurality of user terminals 10 each of which is used by a user and a server 20. A user terminal 10 is an example of an information processing apparatus. The plurality of user terminals 10 include, for example, a first user terminal 10A used by a user U1 and a second user terminal 10B used by another user U2. The number of the user terminals 10 is not particularly limited.

In the information control system 1, for example, the plurality of user terminals 10 and the server 20 are connected to each other by using the Internet or a wired or wireless network. In FIG. 1, the information control system 1 is illustrated as a system that uses a wireless network for connection, as an example. In FIG. 1, the first user terminal 10A and the second user terminal 10B are separately denoted by different reference signs, but if the first user terminal 10A and the second user terminal 10B are not individually referred to, a “user terminal 10” is used for description.

A computing apparatus, such as a desktop computer, a notebook computer, or a tablet computer, constitutes the user terminal 10. The user terminal 10 includes an input unit 15 and a display 16. Various operations on files, such as creating, editing, and storing files, are performed by using the user terminal 10. Examples of files include text files, image files, and files including a combination of text and imagery. In the user terminal 10, for example, various operations on files, such as creating, editing, and storing files, are performed by using the input unit 15, and one or more files are presented on the display 16.

In addition, the user terminal 10 causes the display 16 to present an interrelationship that represents one or more associations between a plurality of files and that is determined in accordance with operation histories of the plurality of files. The interrelationship mentioned here represents one or more associations of some kind, such as a case where a portion of a file A is quoted in a file B or a case where a file B is created by referencing a file A. Further, one or more associations between the plurality of files are changed by using the user terminal 10. For example, when the user U1 performs an operation on a file by using the first user terminal 10A, an interrelationship representing associations between the file and other files is presented on the display 16. One or more associations between a plurality of files can be changed by using the first user terminal 10A.

Files transmitted from other users are also presented by using the user terminal 10. At that time, an interrelationship representing one or more associations between a plurality of files is presented on the display 16. For example, when a file transmitted from the first user terminal 10A is presented by using the second user terminal 10B, an interrelationship representing associations between the file and other files is presented on the display 16. A specific configuration and operation of the user terminal 10 will be described below.

A computing apparatus, such as an on-premises shared server or a cloud server, constitutes the server 20. The server 20 has a function of transmitting a file received from a user to another user in a service provided for a plurality of users. A specific configuration and operation of the server 20 will be described below.

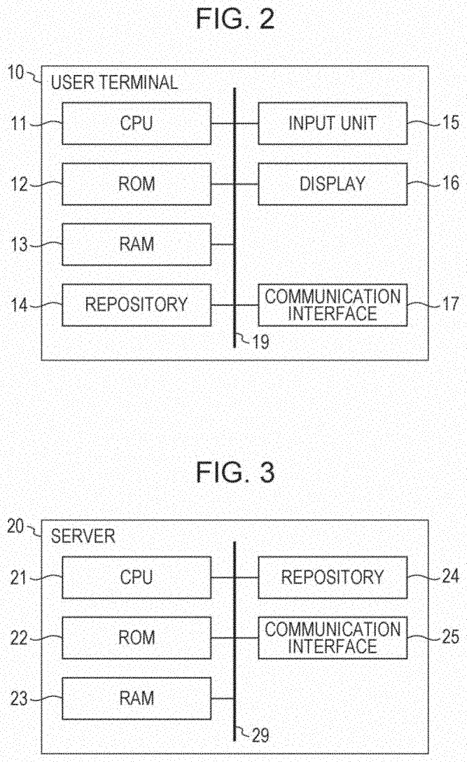

FIG. 2 is a block diagram depicting a hardware configuration of the user terminal 10.

As depicted in FIG. 2, the user terminal 10 includes a central processing unit (CPU or processor) 11, a read-only memory (ROM) 12, a random-access memory (RAM) 13, a repository 14, the input unit 15, the display 16, and a communication interface 17, as components. These components are communicatively connected to each other by using a bus 19.

The CPU 11, which is a central computing processing unit, executes various programs and controls each component. Specifically, the CPU 11 loads programs from the ROM 12 or the repository 14 and uses the RAM 13 as a working space to execute the programs. The CPU 11 controls each component described above and performs various kinds of computing processing in accordance with the programs stored in the ROM 12 or the repository 14. In the present exemplary embodiment, an information processing program is stored in the ROM 12 or the repository 14.

The ROM 12 stores various programs and various kinds of data. The RAM 13 functions as a working space and temporarily retains programs or data. A hard disk drive (HDD) or a solid state drive (SSD) constitutes the repository 14, which stores various programs, such as the operating system, and various kinds of data.

The input unit 15 includes a pointing device, such as a mouse, and a keyboard and is used for receiving various kinds of input.

The display 16 is, for example, a liquid crystal display and presents various kinds of information. A touch panel system may be adopted for the display 16, which may function as the input unit 15.

The communication interface 17 is an interface for communicating with other apparatuses, such as the server 20, and such a standard as the Ethernet (registered trademark), fiber distributed data interface (FDDI), or Wi-Fi (registered trademark) is used.

FIG. 3 is a block diagram depicting a hardware configuration of the server 20.

As depicted in FIG. 3, the server 20 includes a CPU 21, a ROM 22, a RAM 23, a repository 24, and a communication interface 25 as components. These components are communicatively connected to each other by using a bus 29.

The CPU 21, which is a central computing processing unit, executes various programs and controls each component. Specifically, the CPU (processor) 21 loads programs from the ROM 22 or the repository 24 and uses the RAM 23 as a working space to execute the programs. The CPU 21 controls each component described above and performs various kinds of computing processing in accordance with the programs stored in the ROM 22 or the repository 24. In the present exemplary embodiment, an information processing program is stored in the ROM 22 or the repository 24.

The ROM 22 stores various programs and various kinds of data. The RAM 23 functions as a working space and temporarily retains programs or data. An HDD or an SSD constitutes the repository 24, which stores various programs, such as the operating system, and various kinds of data.

The communication interface 25 is an interface for communicating with other apparatuses, such as the plurality of user terminals 10, and such a standard as the Ethernet (registered trademark), FDDI, or Wi-Fi (registered trademark) is used.

Next, functional configurations of the user terminal 10 and the server 20 will be described.

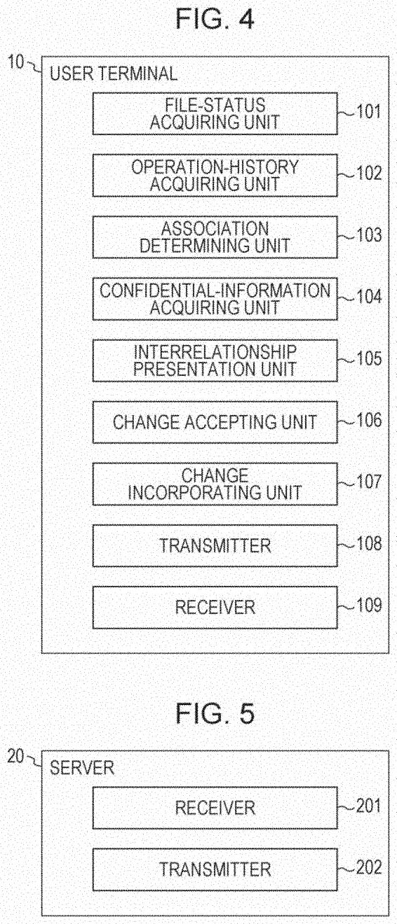

FIG. 4 is a block diagram depicting an example of the functional configuration of the user terminal 10.

As depicted in FIG. 4, the user terminal 10 includes a file-status acquiring unit 101, an operation-history acquiring unit 102, an association determining unit 103, a confidential-information acquiring unit 104, an interrelationship presentation unit 105, a change accepting unit 106, a change incorporating unit 107, a transmitter 108, and a receiver 109, as functional sections. Each functional section is realized by the CPU 11, which reads an information processing program stored in the ROM 12 or the repository 14 and loads the information processing program onto the RAM 13 to execute the program.

The file-status acquiring unit 101 acquires file status. The file status includes operation status of a file, such as opening a file, closing a file, or creating and editing a file. A user performs an operation on a file, for example, by using the input unit 15 of the user terminal 10.

The operation-history acquiring unit 102 acquires operation histories of a plurality of files. Examples of operation histories include the filenames of a plurality of files stored in the user terminal 10, the username of a user who has performed operations on the plurality of files, the date and time of operations on the plurality of files, and details of operations on the plurality of files. Details of operations on a file include, for example, viewing and editing the file and a network connection. As an example, in the first user terminal 10A used by the user U1, if operations are performed on a plurality of files (refer to FIG. 1), the operation histories of the plurality of files are stored in the repository 14 or the like.

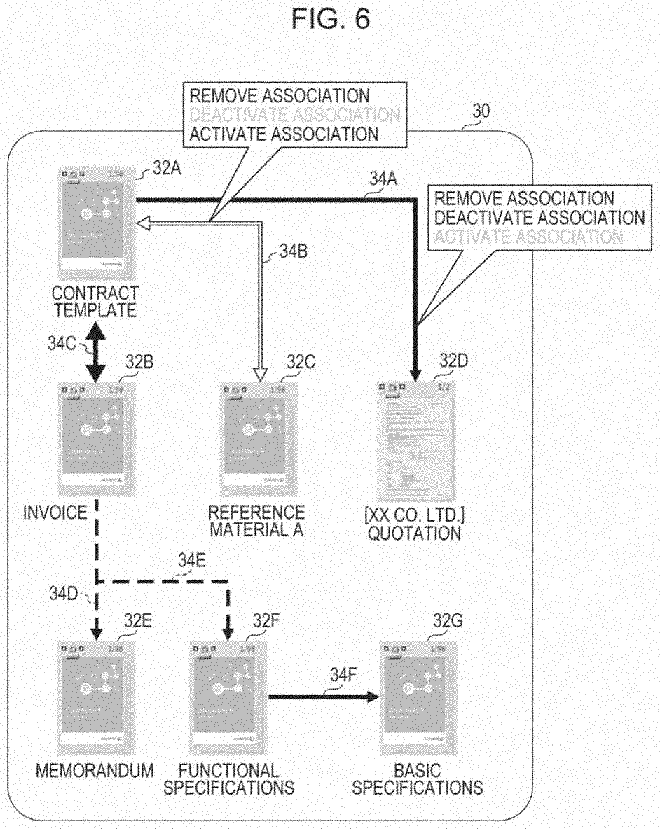

In accordance with the operation histories of the plurality of files, the association determining unit 103 determines an interrelationship representing associations between the plurality of files. For example, the association determining unit 103 calculates the degree of association between two files in accordance with the operation histories of the two files. The degree of association is calculated in accordance with the frequency of simultaneous operations on files and operation details of such simultaneous operations. For example, as the frequency of simultaneous usage of files increases, the degree of association between the files increases. In addition, if a copy of a file is pasted on another file, these two files have a high degree of association. These are examples of calculating a degree of association, and degrees of association between a plurality of files may be calculated by using a specific calculation rule based on the operation histories of the plurality of files. An interrelationship is determined based on whether the value of a degree of association exceeds a plurality of thresholds provided in a stepwise manner. The interrelationship is presented, for example, by using the thickness and type of an association line (for example, refer to association lines 34A to 34F depicted in FIG. 6) that represents the interrelationship between two files by using an arrow. The association determining unit 103 also determines (i) a relationship of referencing indicating that a first file of the plurality of files references a second file during an operation on the first file or (ii) a relationship of being referenced indicating that the first file is referenced during an operation on the second file.

The confidential-information acquiring unit 104 acquires from a plurality of files a file that contains confidential information. Examples of confidential information include customer information. In the present exemplary embodiment, a file having a filename including customer information, such as a customer name, is acquired as a file that contains confidential information. A customer name is identified if such words as “KK”, “Limited”, “Incorporated”, “Company”, “Corporate”, and “Co. Ltd” are included.

The interrelationship presentation unit 105 causes the display 16 to present an interrelationship that represents associations between a plurality of files and that is determined by the association determining unit 103. For example, an interrelationship diagram (refer to an interrelationship diagram 30 depicted in FIG. 6) is presented on the display 16 as an interrelationship representing associations between a plurality of files. In the interrelationship diagram 30 depicted in FIG. 6, for example, an interrelationship between two files is presented by using one of the association lines 34A to 34F each represented by an arrow. Further, for example, the direction of an arrow representing one of the association lines 34A to 34F indicates (i) the information regarding a relationship of referencing indicating that a first file of the plurality of files references a second file during an operation on the first file or (ii) the information regarding a relationship of being referenced indicating that the first file is referenced during an operation on the second file. For example, the directions of the arrows representing the association lines 34A to 34F are determined so that a file located at an arrowhead is referenced during a file operation. The interpretation of the association lines 34A to 34F in the interrelationship diagram depicted in FIG. 6 will be described below.

Further, as depicted in FIG. 6, the interrelationship presentation unit 105 presents a file that contains confidential information and that is acquired by the confidential-information acquiring unit 104 so that the file that contains confidential information is distinguishable from files that contain no confidential information. For example, a file 32D that contains confidential information is presented in color, and files 32A, 32B, 32C, 32E, 32F, and 32G that contain no confidential information are presented in monochrome. A file that contains confidential information needs to be distinguishable from a file that contains no confidential information. For example, a file that contains confidential information may be presented in chromatic color, and a file that contains no confidential information may be presented in achromatic color.

The change accepting unit 106 accepts a change in associations between files. An example of a change in associations is an operation of canceling an association between files. Examples of cancellation include removing an association between files and deactivating an association between files. In the present exemplary embodiment, if an association between files is removed, the association between the files cannot be restored, but if an association between files is deactivated, the association between the files can be restored (that is, brought back to the original condition).

The change incorporating unit 107 incorporates a change in associations between files into an interrelationship representing associations between a plurality of files if the change in associations between the files is accepted by the change accepting unit 106. For example, if canceling an association between files is accepted, the cancellation is incorporated into the presentation of an interrelationship diagram (refer to FIG. 6), and a portion representing the canceled association between the files is not presented in the interrelationship diagram.

The transmitter 108 transmits to the server 20 files, operation histories of files, interrelationships representing associations between a plurality of files, and the like. As an example, the first user terminal 10A transmits to the server 20 files, operation histories of files, interrelationships representing associations between a plurality of files, and the like.

The receiver 109 receives from the server 20 files transmitted to the server 20 from another user terminal 10, operation histories of files, interrelationships representing associations between a plurality of files, and the like. As an example, the second user terminal 10B receives from the server 20 files transmitted from the first user terminal 10A, operation histories of files, interrelationships representing associations between a plurality of files.

FIG. 5 is a block diagram depicting an example of the functional configuration of the server 20.

As depicted in FIG. 5, the server 20 includes a receiver 201 and a transmitter 202 as functional sections. Each functional section is realized by the CPU 21, which reads an information processing program stored in the ROM 22 or the repository 24 and loads the information processing program onto the RAM 23 to execute the program.

The receiver 201 receives files transmitted from the plurality of user terminals 10, operation histories of files, interrelationships representing associations between a plurality of files, and the like. As an example, the receiver 201 receives files, operation histories of files, interrelationships representing associations between a plurality of files, and the like, which are transmitted from the first user terminal 10A.

The transmitter 202 transmits to the plurality of user terminals 10 files, operation histories of files, interrelationships representing associations between a plurality of files, and the like. As an example, the transmitter 202 transmits to the second user terminal 10B files, operation histories of files, interrelationships representing associations between a plurality of files, and the like, which are received from the first user terminal 10A.

FIG. 6 depicts an example of an interrelationship diagram presented on the display 16 of the user terminal 10. As depicted in FIG. 6, the interrelationship diagram 30 presents a plurality of files (for example, 7 files) 32A to 32G, and each of the files 32A to 32G is presented with a filename. Each icon of the files 32A to 32G is presented by using a thumbnail image. A thumbnail image is image data representing an image greatly reduced from the original size.

An interrelationship representing associations between the files 32A to 32G is presented by using the association lines 34A to 34F, which use arrows to represent the interrelationship between the files 32A to 32G.

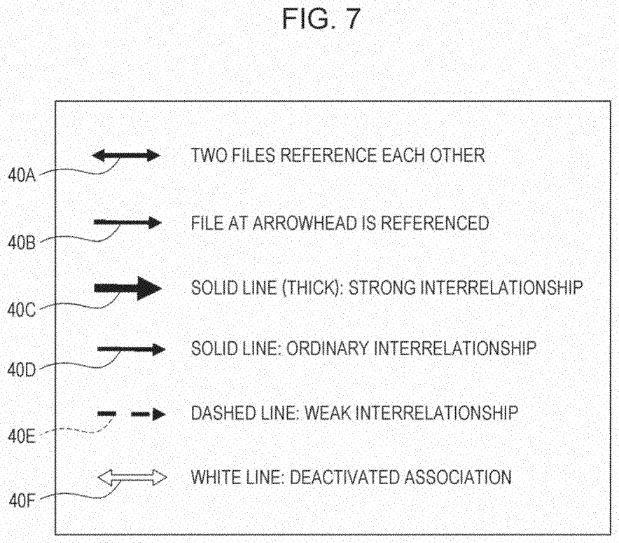

FIG. 7 depicts types of association lines. As depicted in FIG. 7, an association line 40A, which has arrowheads one each on opposite ends, represents a case where two files are mutually referenced during editing, and each of the two files is presented as a recommended file for the other. An association line 40B, which has an arrowhead only on one end, represents a case where a file at the arrowhead has relevance. In other words, the association line 40B indicates (i) the information regarding a relationship of referencing indicating that a first file undergoing an edit references a second file, which is located at the arrowhead, and (ii) the information regarding a relationship of being referenced indicating that the second file is referenced.

An association line 40C, which is a thicker solid line than an association line 40D having a standard thickness, indicates a strong interrelationship between files. The association line 40D, which is a solid line having the standard thickness, indicates that an interrelationship between files is ordinary (normal), that is, at an average level. An association line 40E that is a dashed line indicates a weak interrelationship between files. Further, an association line 40F that is white indicates that the association is deactivated. In other words, the association line 40F indicates that the association is deactivated but can be thereafter restored (that is, brought back to the original condition). The fact that no association line is drawn between two files indicates that the two files have no association.

Presentation of interrelationships in this way enables a user to grasp the magnitude of an interrelationship between files and the relationships of referencing and being referenced. Instead of presenting the association lines as described above, an association line may be colored differently in accordance with the magnitude of an interrelationship without changing the thickness or the type of the association line. Alternatively, an association line may be colored differently in addition to changing the thickness or the type of the association line.

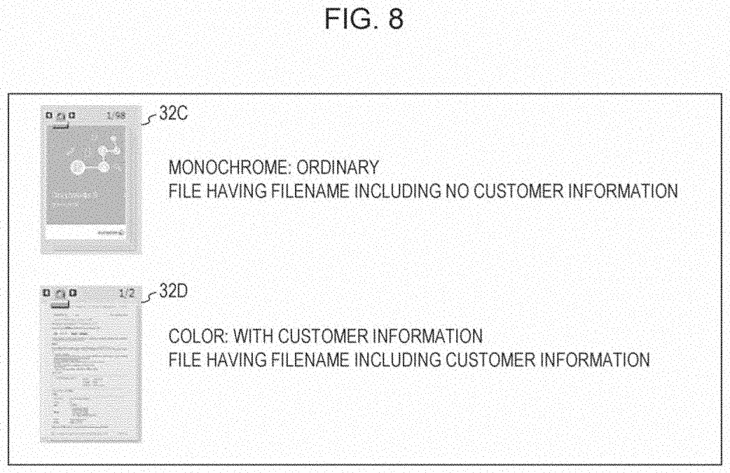

FIG. 8 depicts presentation conditions of a file that contains confidential information and a file that contains no confidential information. As depicted in FIG. 8, the file 32C, which contains no confidential information, is represented by a thumbnail image in monochrome. The file 32D, which contains confidential information, is represented by a thumbnail image in color. In short, the file 32D, which contains confidential information, is presented so as to be distinguishable from the file 32C, which contains no confidential information. As described above, a file having a filename including customer information, such as a customer name, is presented as a file that contains confidential information, such as the file 32D. Instead of the presentation above, the file 32D, which contains confidential information, may be presented in chromatic color, and the file 32C, which contains no confidential information, may be presented in achromatic color.

In this way, a file that contains confidential information is presented so as to be distinguishable from a file that contains no confidential information, and thus the user is able to pay attention to the file that contains confidential information and to check an interrelationship that involves the file that contains confidential information in an interrelationship diagram.

The presentation of the interrelationship diagram 30 depicted in FIG. 6 changes in real time in accordance with a file operation or a change in associations between files. For example, if the file 32A is edited while the file 32A and the file 32D are opened, the association between the file 32A and the file 32D is formed, and the association line 34A is presented between the file 32A and the file 32D. Further, if the file 32A or the file 32D is closed after the file 32A and the file 32D are associated with each other, the interrelationship may be hidden.

If an association between two files is to be changed, a right click on the association line between the two files enables the user to select one of three items “Remove the association”, “Deactivate the association”, and “Activate the association”. In this way, the presentation of the association line is changed. Although not depicted in the figures, if the item “Remove the association” is selected, the selected association line disappears. The removed association line will not be presented thereafter. The item “Remove the association” can be selected irrespective of the condition of an association line (refer to the association lines 34A and 34B in FIG. 6).

For example, a right click on the association line 34B between the file 32A and the file 32C followed by the selection of the item “Deactivate the association” causes the association line 34B, which is selected, to become white. A right click on the association line 34B for a second time makes the item “Deactivate the association” unselectable (refer to the association line 34B in FIG. 6).

The item “Activate the association” is selectable only when the association line 34B between the file 32A and the file 32C is white (refer to the association line 34B in FIG. 6). When the association line 34B between the file 32A and the file 32C is white, a right click on the association line 34B followed by the selection of the item “Activate the association” causes the association line 34B, which is selected, to return to the original solid association line.

For example, when the item “Activate the association” is selected, the solid association line 34A is presented between the file 32A and the file 32D. A right click on the association line 34A, which is presented as a solid line between the file 32A and the file 32D, enables the user to select the item “Remove the association” or the item “Deactivate the association”.

In the interrelationship diagram 30 depicted in FIG. 6, the file 32D, which contains confidential information, is presented in color and is distinguishable from the files 32A, 32B, 32C, 32E, 32F, and 32G, which contain no confidential information and are presented in monochrome. If the association between the file 32A and the file 32D is not expected to be restored to the original condition, the item “Remove the association” is selected on the association line 34A. Thus, the selected association line disappears, and the removed association line will not be presented.

In this way, a change in an interrelationship is accepted in an interrelationship diagram, and if files are associated with each other and the association is not intended by the user, the interrelationship can be corrected so as to be in line with the intention of the user.

Next, an operation of the information processing apparatus will be described.

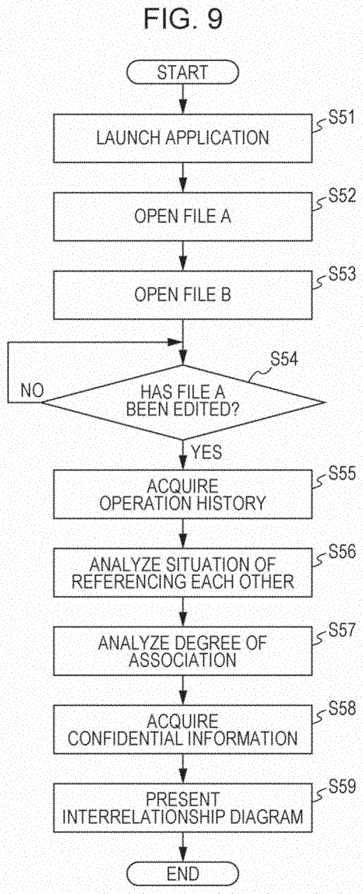

FIG. 9 is a flowchart depicting a flow of an information processing operation performed by using the user terminal 10, as an example of the information processing apparatus. The CPU 11 reads an information processing program stored in the ROM 12 or the repository 14 and loads the information processing program onto the RAM 13 to execute the program, and then the information processing operation is performed.

As depicted in FIG. 9, the CPU 11 launches an application related to the information processing operation (step S51). For example, the user U1, who uses the first user terminal 10A, performs an input operation for a launch by using the input unit 15, and then the application related to the information processing operation is launched. Just after the application is launched, no interrelationship diagram is presented on the display 16 of the first user terminal 10A.

The CPU 11 opens any file, which is referred to as a file A (step S52). For example, the user U1, who uses the first user terminal 10A, performs by using the input unit 15 an input operation to open the file 32A, which is an example of the file A, and the file 32A is opened. As a result, the file 32A is presented on the display 16 of the first user terminal 10A.

The CPU 11 opens another file, which differs from the file A and is referred to as a file B (step S53). For example, the user U1, who uses the first user terminal 10A, performs by using the input unit 15 an input operation to open the file 32B, which is an example of the file B, and the file 32B is opened. As a result, the file 32B is presented on the display 16 of the first user terminal 10A.

The CPU 11 determines whether the file A has been edited (step S54). For example, when the date and time of the update of the file 32A, which is an example of the file A, are changed, the CPU 11 determines that the file 32A has undergone an editing process. If the file A has not been edited (NO in step S54), the CPU 11 waits for the file A to be edited.

If the file A has been edited (YES in step S54), the CPU 11 acquires the operation history regarding the file A (step S55). For example, the operation history regarding the file 32A, as an example of the file A, is acquired.

In accordance with the acquired operation history, the CPU 11 analyzes a situation in which the file A and the file B reference each other during editing (step S56). Based on the analysis, the association line is determined to be a double-pointed arrow or a single-pointed arrow. For example, the CPU 11 analyzes whether the file 32B has been edited while the file 32A is open. If the operation history indicates that the file 32B has been edited while the file 32A is open, the CPU 11 determines that the association line be a double-pointed arrow, such as the association line 40A (refer to FIG. 7). If the operation history indicates that the file 32B has not been edited while the file 32A is open, the CPU 11 determines that the association line be a single-pointed arrow, such as the association line 40B, “directed from the file 32A to the file 32B” (refer to FIG. 7).

In accordance with the acquired operation history, the CPU 11 analyzes the degree of association between the file A and the file B (step S57). The thickness and the type (a solid line or a dashed line) of the association line are determined based on the analysis.

If the calculated value of the degree of association is higher than a first threshold, the CPU 11 determines that the degree of association between the file 32A and the file 32B is at a high level and selects the association line 40C, which is a thicker solid line than the association line 40D, which has the standard thickness (refer to FIG. 7). If the calculated value of the degree of association is equal to or lower than the first threshold and equal to or higher than a second threshold, the CPU 11 determines that the degree of association between the file 32A and the file 32B is at a standard level and selects the association line 40D, which has the standard (normal) thickness. If the calculated value of the degree of association is lower than the second threshold, the CPU 11 determines that the degree of association between the file 32A and the file 32B is at a low level and selects the association line 40E, which is a dashed line.

The CPU 11 acquires confidential information from the file A and the file B, which are presented (step S58). For example, a file having a filename including customer information, such as a customer name, is acquired as confidential information, and a file that contains customer information is distinguished from a file that contains no customer information. For example, the file 32A and the file 32B each have a filename including no customer information.

The CPU 11 presents an interrelationship diagram (step S59). For example, if the association line 40A, which has arrowheads one each on opposite ends, is selected in step S56 and the association line 40C, which is a thicker solid line than the association line 40D, which has the standard thickness, is selected in step S57, the association line 34C, which is a thick solid line that has arrowheads one each on opposite ends, is presented between the file 32A and the file 32B (refer to FIG. 6).

In addition, if a file that contains customer information and that is acquired in step S58 is present, such a file is presented so as to be distinguishable from a file that contains no customer information. For example, a file that contains customer information is presented in color, and a file that contains no customer information is presented in monochrome. For example, since the file 32A and the file 32B each have a filename that contains no customer information, the file 32A and the file 32B are presented in monochrome, as files that contain no customer information (refer to FIG. 6). Thus, the process based on the information processing program is finished.

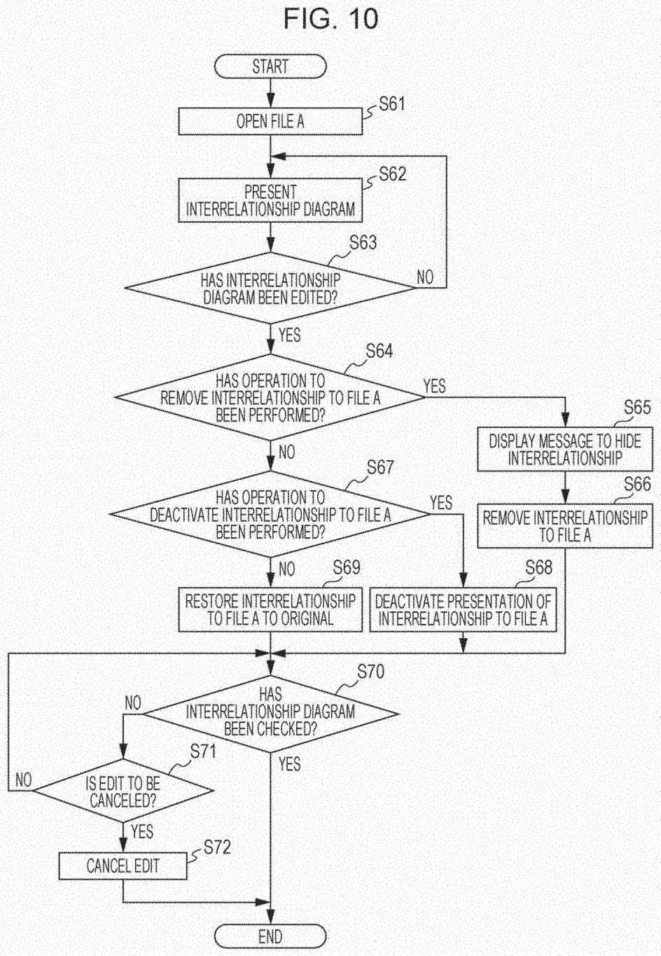

FIG. 10 is a flowchart depicting a flow of a change process performed by using the user terminal 10. In the change process, the presentation of an association line between files in an interrelationship diagram is changed. The CPU 11 reads a change process program stored in the ROM 12 or the repository 14 and loads the change process program onto the RAM 13 to execute the program, and then the change process is performed.

As depicted in FIG. 10, the CPU 11 opens any file, which is referred to as a file A (step S61). For example, the user U1, who uses the first user terminal 10A, performs by using the input unit 15 an input operation to open the file 32A, which is an example of the file A, and the file 32A is opened.

The CPU 11 presents an interrelationship diagram regarding the file A (step S62). For example, an interrelationship diagram regarding the file 32A, which is an example of the file A, is presented on the display 16 of the first user terminal 10A. For example, as depicted in FIG. 6, the file 32A and the file 32D are associated with each other, and the association line 34A is presented to represent an interrelationship between the file 32A and the file 32D.

The CPU 11 determines whether the interrelationship diagram has been edited (step S63). For example, when the date and time of the update of the interrelationship diagram are changed, the CPU 11 determines that the interrelationship diagram has undergone an editing process.

If the interrelationship diagram has not been edited (NO in step S63), the CPU 11 makes the process return to step S62.

If the interrelationship diagram has been edited (YES in step S63), the CPU 11 determines whether an operation to remove an interrelationship to the file A has been performed (step S64). For example, as depicted in FIG. 6, if the association line 34A between the file 32A and the file 32D is right-clicked and thereafter the item “Remove the association” is selected, it is determined that an operation to remove an interrelationship to the file 32A has been performed.

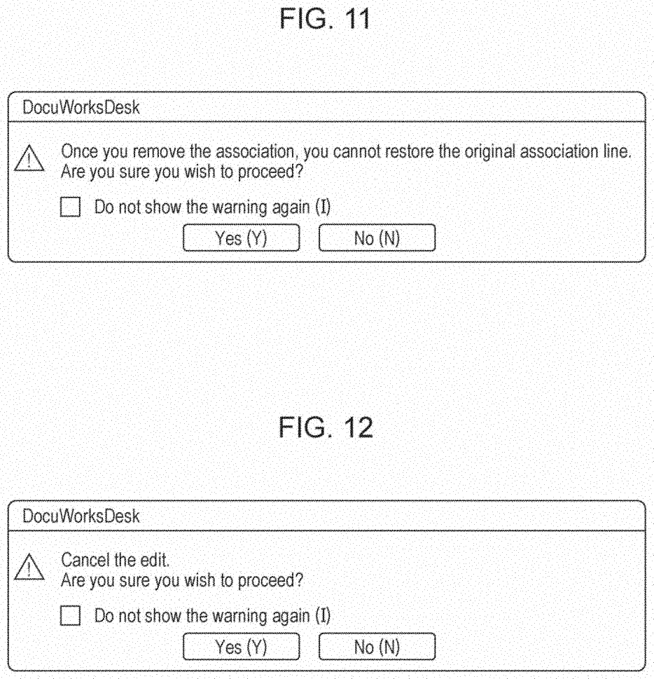

If the operation to remove the interrelationship to the file A has been performed (YES in step S64), the CPU 11 displays a message seeking approval for hiding the interrelationship (step S65). For example, as depicted in FIG. 11, a warning dialog is presented on the display 16 of the first user terminal 10A. In the warning dialog, one of “Yes (Y)” and “No (N)” is selectable. By using the warning dialog, for example, a check is performed on whether the association line 34A between the file 32A and the file 32D is allowed to be removed.

After checking the presented message, the CPU 11 removes the interrelationship to the file A (step S66). As depicted in FIG. 11, if “Yes (Y)” in the warning dialog is selected, for example, the association line 34A between the file 32A and the file 32D is removed. Once the association line 34A is removed, the association line 34A cannot be brought back to the original condition (restored).

If the operation to remove the interrelationship to the file A has not been performed (NO in step S64), the CPU 11 determines whether an operation to deactivate the interrelationship to the file A has been performed (step S67). For example, as depicted in FIG. 6, if the association line 34A between the file 32A and the file 32D is right-clicked and thereafter the item “Deactivate the association” is selected, it is determined that the operation to deactivate the interrelationship to the file 32A has been performed.

If the operation to deactivate the interrelationship to the file A has been performed (YES in step S67), the CPU 11 deactivates the presentation of the interrelationship to the file A (step S68). Although not depicted in the figures, if the operation to deactivate the interrelationship between the file 32A and the file 32D is performed, the association line 34A between the file 32A and the file 32D is presented in white. When the association line 34A between the file 32A and the file 32D is presented in white, for example, if the file 32A is transmitted from the first user terminal 10A to the second user terminal 10B via the server 20, the file 32D is not presented as a recommended document when the file 32A is presented at the second user terminal 10B.

If the operation to deactivate the interrelationship to the file A has not been performed (NO in step S67), the CPU 11 restores the interrelationship to the file A to the original presentation (step S69). For example, as depicted in FIG. 6, a case where the operation to deactivate the interrelationship to the file 32A has not been performed corresponds to a case where the association line 34B between the file 32A and the file 32C is right-clicked and thereafter the item “Activate the association” is selected. In this case, the association line 34B between the file 32A and the file 32C is restored to the original solid line.

When the interrelationship diagram is sent from a user terminal A to a user terminal B and presented at the user terminal B, the association line between the file 32A and the file 32D, whose interrelationship is deactivated, may be presented in white, and an operation to restore the interrelationship between the file 32A and the file 32D may be accepted at the user terminal B to restore the association line to the original solid line.

After the step S66, the step S68, or the step S69 is performed, the CPU 11 determines whether the interrelationship diagram has been checked (step S70). Although not depicted in the figures, the interrelationship diagram is checked by displaying a warning message “Has this interrelationship diagram been checked?”, and the user is requested to select one of “Yes (Y)” and “No (N)”. If “Yes (Y)” is selected, it is determined that the interrelationship diagram has been checked.

If the interrelationship diagram has been checked (YES in step S70), the CPU 11 finishes the process based on the change process program.

If the interrelationship diagram has not been checked (NO in step S70), the CPU 11 determines whether the edit of the interrelationship diagram is to be canceled (step S71). For example, as depicted in FIG. 12, a confirmation message “Cancel the edit. Are you sure you wish to proceed?” is displayed to determine whether to cancel the edit of the interrelationship diagram, and the user is requested to select one of “Yes (Y)” and “No (N)”. If “Yes (Y)” is selected, it is determined that the edit is to be canceled.

If it is determined that the edit of the interrelationship diagram is not to be canceled (NO in step S71), the CPU 11 makes the process return to step S70.

If it is determined that the edit of the interrelationship diagram is to be canceled (YES in step S71), the CPU 11 cancels the edit of the interrelationship diagram (step S72). The interrelationship diagram returns to the original condition, and the interrelationship diagram before the edit is presented. Thus, the process based on the change process program is finished. In some cases, the user U1 edits the interrelationship diagram in more than one place. In such a case, after step S70 or step S72 is performed, it may be determined whether the edit of the interrelationship diagram is to be continued, and if it is determined that the edit of the interrelationship diagram is to be continued, the process may return to step S63. For example, a warning message “Do you want to continue editing the interrelationship diagram?” is displayed to check whether to continue editing the interrelationship diagram, and the user is requested to select one of “Yes (Y)” and “No (N)”. If “Yes (Y)” is selected, it is determined that the edit of the interrelationship diagram is continued.

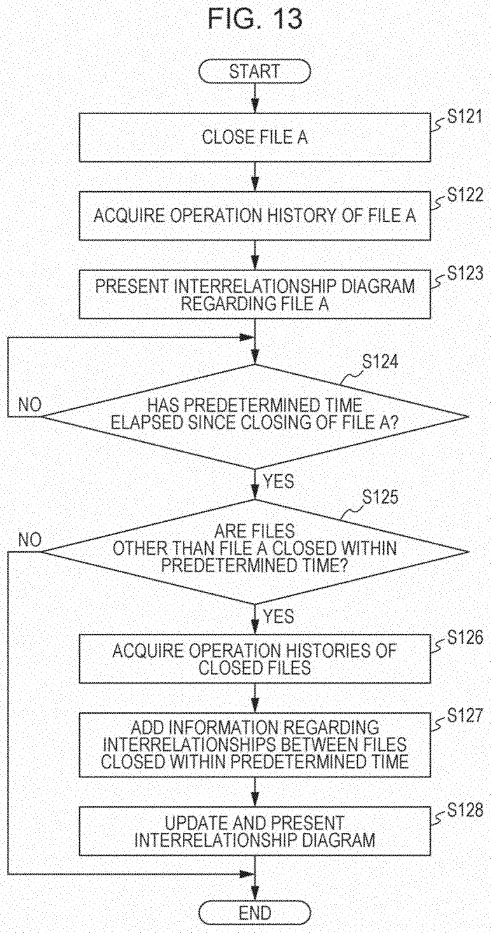

FIG. 13 is a flowchart depicting a flow of an update process performed by using the user terminal 10 for updating an interrelationship diagram. In the update process, interrelationships between a plurality of files in the interrelationship diagram are updated. The CPU 11 reads an update process program stored in the ROM 12 or the repository 14 and loads the update process program onto the RAM 13 to execute the program, and then the update process is performed.

As depicted in FIG. 13, the CPU 11 closes any file, which is referred to as a file A (step S121). For example, the user U1, who uses the first user terminal 10A, performs by using the input unit 15 an input operation to close the file 32A, which is an example of the file A, and the file 32A is closed.

The CPU 11 acquires the operation history of the file A (step S122). For example, the operation history of the file 32A is acquired once the file 32A is closed.

The CPU 11 presents an interrelationship diagram regarding the file A (step S123). For example, the interrelationship diagram regarding the file 32A is presented on the display 16 of the first user terminal 10A.

The CPU 11 determines whether a predetermined amount of time has elapsed since the closing of the file A (step S124). For example, it is determined whether the predetermined amount of time has elapsed since the closing of the file 32A. If it is determined that the predetermined amount of time has not elapsed since the closing of the file A (NO in step S124), the CPU 11 waits until the predetermined amount of time elapses after the closing of the file A. For example, the “predetermined amount of time” may be set to a specific value, such as 2 hours, 4 hours, or 6 hours.

If it is determined that the predetermined amount of time has elapsed since the closing of the file A (YES in step S124), the CPU 11 determines whether one or more files other than the file A are closed within the predetermined amount of time after the closing of the file A (step S125). For example, it is determined whether one or more files other than the file 32A are closed within the predetermined amount of time after the closing of the file 32A.

If it is determined that no file other than the file A is closed within the predetermined amount of time after the closing of the file A (NO in step S125), the CPU 11 finishes the process based on the update process program.

If it is determined that one or more files other than the file A are closed within the predetermined amount of time after the closing of the file A (YES in step S125), the CPU 11 acquires the operation histories of the one or more files that are closed (step S126). For example, as depicted in FIG. 6, if the files 32E, 32F, and 32G are closed within the predetermined amount of time after the closing of the file 32A, the operation histories of the files 32E, 32F, and 32G, which are closed, are acquired.

The CPU 11 adds to the interrelationship diagram regarding the file A the information regarding interrelationships representing associations between the files closed within the predetermined amount of time after the closing of the file A (step S127). For example, as depicted in FIG. 6, in accordance with the operation histories of the files 32E, 32F, and 32G, which are closed within the predetermined amount of time after the closing of the file 32A, the information regarding interrelationships representing associations between the files 32E, 32F, and 32G is added.

The CPU 11 updates and presents the interrelationship diagram (step S128). For example, as depicted in FIG. 6, the CPU 11 causes the display 16 of the first user terminal 10A to present the interrelationship diagram 30, which is obtained by adding to the interrelationship diagram regarding the file 32A the information regarding the interrelationships representing the associations between the files 32E, 32F, and 32G. In this way, the process based on the update process program is finished.

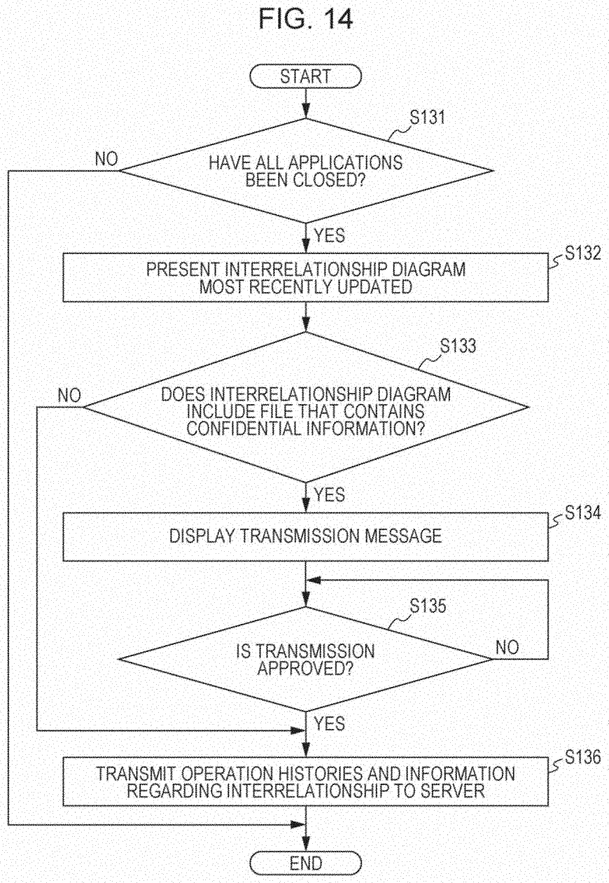

FIG. 14 is a flowchart depicting a flow of a transmission process performed by using the user terminal 10. In the transmission process, information regarding interrelationships between files is transmitted to the server 20. The CPU 11 reads a transmission process program stored in the ROM 12 or the repository 14 and loads the transmission process program onto the RAM 13 to execute the program, and then the transmission process is performed.

As depicted in FIG. 14, the CPU 11 determines whether all the applications that operate files have been closed (step S131). For example, if all the files presented on the display 16 of the first user terminal 10A are closed, it is determined that all the applications are closed.

If at least one application, which operates files, is not closed (NO in step S131), the CPU 11 finishes the process based on the transmission process program.

If all the applications, which operate files, are closed (YES in step S131), the CPU 11 presents an interrelationship diagram most recently updated (step S132). If the interrelationship diagram is updated in the update process based on the flowchart depicted in FIG. 13, the interrelationship diagram 30, which is most recently updated, is presented, as depicted in FIG. 6.

The CPU 11 determines whether the interrelationship diagram includes one or more files that contain confidential information (step S133). For example, the interrelationship diagram 30, which includes the file 32D, as depicted in FIG. 6, is an example of the interrelationship diagram including a file that contains confidential information (customer information in the present exemplary embodiment). For example, in the interrelationship diagram 30 depicted in FIG. 6, the file 32D, which contains confidential information, is presented in gray and is distinguishable from the files 32A, 32B, 32C, 32E, 32F, and 32G, which contain no confidential information.

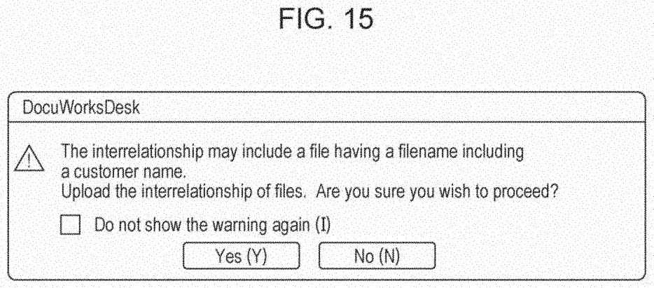

If the interrelationship diagram includes one or more files that contain confidential information (YES in step S133), the CPU 11 displays a message seeking approval for transmission of the interrelationship between files (step S134). For example, as depicted in FIG. 15, the message seeking approval for transmission is presented as a warning dialog before uploading the interrelationship. The warning dialog indicates that the interrelationship may include a file having a filename including a customer name and inquires whether the interrelationship may be uploaded, and the user is requested to select one of “Yes (Y)” and “No (N)”.

The CPU 11 determines whether the transmission is approved (step S135). For example, if “Yes (Y)” is selected in the warning dialog depicted in FIG. 15, it is determined that the transmission is approved. If “No (N)” is selected, it is determined that the transmission is not approved. If it is determined that the transmission is not approved (NO in step S135), the CPU 11 waits for the transmission to be approved. The user may be allowed to change the interrelationship diagram in the change process for the interrelationship diagram, which is described from step S63 to step S70 in the change process depicted in FIG. 10.

If the transmission is approved (YES in step S135), the CPU 11 transmits to the server 20 the operation histories and the information regarding the interrelationship (step S136). This transmission finishes the process based on the transmission process program.

If the interrelationship diagram does not include a file that contains confidential information (NO in step S133), the CPU 11 makes the process proceed to step S136 and transmits to the server 20 the operation histories and the information regarding the interrelationship (step S136). This transmission finishes the process based on the transmission process program. In this example, instead of transmitting the interrelationship diagram, only the information regarding the interrelationship representing associations between files is transmitted, but the information including the interrelationship diagram as well as the information regarding the interrelationship may be sent.

In the flowchart depicted in FIG. 14, if the interrelationship diagram includes one or more files that contain confidential information, approval for transmission of the interrelationship of files is requested. However, this is not meant to be limiting. Approval for transmission of the interrelationship of files may be requested, irrespective of whether the interrelationship diagram includes one or more files that contain confidential information.

While a plurality of files are presented at the user terminal 10 described above, if an operation performed on one or more files forms associations between the plurality of files, a user can grasp an interrelationship between the plurality of files caused by the associations.

The processes performed by the user terminal 10 and the server 20 may also be achieved by using a dedicated hardware circuit. In such a case, a piece of hardware may perform the processes, or a plurality of pieces of hardware may perform the processes.

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The programs for operating the user terminal 10 and the server 20 may be provided by using a computer readable recording medium, such as a universal-serial-bus (USB) memory, a flexible disc, or a compact disc read-only memory (CD-ROM), or may be provided online via a network, such as the Internet. In such cases, the programs recorded in a computer readable recording medium are typically transferred to and stored in a memory or a repository. Further, these programs may be provided as stand-alone application software or may be built into software of the user terminal 10 or the server 20 as an integral function.

The specific exemplary embodiment according to the present disclosure has been described in detail, but the present disclosure is not limited to the exemplary embodiment described above. It will be apparent to those skilled in the art that various other embodiments are possible without departing from the scope of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
at least one processor configured to
cause a display to present an interrelationship that represents one or more associations between a plurality of files by generating a graphical indication between a graphical representation of at least two of the plurality of files, the interrelationship being determined in accordance with a history of operation of the plurality of files performed in a state in which the plurality of files are presented on the display.

2. The information processing apparatus according to claim 1,
wherein in presenting the interrelationship, of the plurality of files, the processor presents one or more files that contain confidential information so that the one or more files that contain the confidential information are distinguishable from one or more files that do not contain the confidential information.

3. The information processing apparatus according to claim 1,
wherein in presenting the interrelationship, the processor presents (i) information regarding a relationship of referencing indicating that a second file of the plurality of files has been referenced during an operation on a first file of the plurality of files or (ii) information regarding a relationship of being referenced indicating that the first file has been referenced during an operation on the second file.

4. The information processing apparatus according to claim 2,
wherein in presenting the interrelationship, the processor presents (i) information regarding a relationship of referencing indicating that a second file of the plurality of files has been referenced during an operation on a first file of the plurality of files or (ii) information regarding a relationship of being referenced indicating that the first file has been referenced during an operation on the second file.

5. The information processing apparatus according to claim 1,
wherein the processor accepts a change in an association between files and incorporates the change into presentation of the interrelationship.

6. The information processing apparatus according to claim 2,
wherein the processor accepts a change in an association between files and incorporates the change into presentation of the interrelationship.

7. The information processing apparatus according to claim 3,
wherein the processor accepts a change in an association between files and incorporates the change into presentation of the interrelationship.

8. The information processing apparatus according to claim 4,
wherein the processor accepts a change in an association between files and incorporates the change into presentation of the interrelationship.

9. The information processing apparatus according to claim 5,
wherein the processor accepts cancellation of the association between the files as the change, and
cancels the association between the files in response to acceptance of the cancellation.

10. The information processing apparatus according to claim 6,
wherein the processor accepts cancellation of the association between the files as the change, and
cancels the association between the files in response to acceptance of the cancellation.

11. The information processing apparatus according to claim 7,
wherein the processor accepts cancellation of the association between the files as the change, and
cancels the association between the files in response to acceptance of the cancellation.

12. The information processing apparatus according to claim 8,
wherein the processor accepts cancellation of the association between the files as the change, and
cancels the association between the files in response to acceptance of the cancellation.

13. The information processing apparatus according to claim 9,
wherein the cancellation includes a case where the association between the files is removed and a case where the association between the files can be restored after being canceled.

14. The information processing apparatus according to claim 10,
wherein the cancellation includes a case where the association between the files is removed and a case where the association between the files can be restored after being canceled.

15. The information processing apparatus according to claim 11,
wherein the cancellation includes a case where the association between the files is removed and a case where the association between the files can be restored after being canceled.

16. The information processing apparatus according to claim 12,
wherein the cancellation includes a case where the association between the files is removed and a case where the association between the files can be restored after being canceled.

17. The information processing apparatus according to claim 5,
wherein the processor is capable of transmitting the interrelationship to outside and causes the display to present the interrelationship before the transmission.

18. The information processing apparatus according to claim 1,
wherein after closing a file that is presented, the processor presents the interrelationship related to the file that has been closed.

19. The information processing apparatus according to claim 18,
wherein the processor associates files that are closed within a predetermined amount of time with each other in accordance with the history of operation and presents the interrelationship.

20. A non-transitory computer readable medium storing a program causing a computer to execute a process for information processing, the process comprising:
causing a display to present an interrelationship that represents one or more associations between a plurality of files by generating a graphical indication between a graphical representation of at least two of the plurality of files, the interrelationship being determined in accordance with a history of operation of the plurality of files performed in a state in which the plurality of files are presented on the display.
